(19) United States
(12) Patent Application Publication
(10) Pub. No.: US 2020/0245051 A1
(43) Pub. Date: Jul. 30, 2020

(54) BLUETOOTH HEADSET CONTROL METHOD, BLUETOOTH HEADSET, AND COMPUTER READABLE STORAGE MEDIUM

(71) Applicant: Aukey Technology Co.,Ltd, Shenzhen (CN)

(72) Inventors: Tian HOU, Shenzhen (CN); Changxing XIA, Shenzhen (CN); Chao DENG, Shenzhen (CN)

(21) Appl. No.: 16/442,782

(22) Filed: Jun. 17, 2019

(30) Foreign Application Priority Data
Jan. 28, 2019 (CN) 201910084911.X

(51) Int. Cl. H04R 1/10; H04R 5/033; G06F 3/16; H04W 4/80

(52) U.S. Cl. CPC H04R 1/1041; H04R 5/033; H04R 2420/07; H04W 4/80; G06F 3/167

(57) ABSTRACT

The present application discloses a Bluetooth headset control method, a Bluetooth headset, and a computer readable storage medium. The Bluetooth headset comprises an attraction device, and two sub-headsets, when the Bluetooth headset is in the switch-off state, the two sub-headsets are attracted together through the attraction device. The method includes the following operations: switching on the Bluetooth headset, and connecting the Bluetooth headset with a corresponding target terminal through Bluetooth, when separation of the two sub-headsets is detected; receiving a terminal audio signal sent by the target terminal, and playing audio according to the terminal audio signal, when the connection between the Bluetooth headset and the target terminal is successfully established; executing corresponding headset control operation, when the two sub-headsets are detected to be attracted together through the attraction device.

### CROSS REFERENCE

The present application claims the priority of a Chinese patent application filed in the China patent office on Jan. 28, 2019 with application No. 201910084911.X and the title “BLUETOOTH HEADSET CONTROL METHOD, BLUETOOTH HEADSET, AND COMPUTER READABLE STORAGE MEDIUM”, the entire contents of which are hereby incorporated by reference.

### FIELD

The present application relates to the technical field of wearable device, in particular, relates to a Bluetooth headset control method, a headset, and a computer readable storage medium.

### BACKGROUND

With the continuous improvement of technology, the wearable device market has developed rapidly, and numerous types of headsets are emerging, which includes Bluetooth headsets. A Bluetooth headset may connect with its matching terminal wirelessly, thereby users are allowed to use the headset conveniently without the tie of wires.

However, currently, for the Bluetooth headsets in the market, the working state thereof is generally controlled in a manner of pressing keys, such as, switching on and off the Bluetooth headsets through switch-on and switch-off keys, and playing/pausing music through a playing key, which is inconvenient for users.

### SUMMARY

The main object of the present application is to provide a Bluetooth headset control method, a Bluetooth headset, and a computer readable storage medium, which may solve the technical problem that the current Bluetooth headset is inconvenient to control.

To achieve the above object, the present application provides a Bluetooth headset control method, the Bluetooth headset control method is applied to a Bluetooth headset, the Bluetooth headset includes an attraction device, and the Bluetooth headset also includes two sub-headsets; when the Bluetooth headset is in the switch-off state, the two sub-headsets are attracted together through the attraction device;

the Bluetooth headset control method includes the following operations:

when separation of the two sub-headsets is detected, switching on the Bluetooth headset, and connecting the Bluetooth headset with a corresponding target terminal through Bluetooth;

when the connection between the Bluetooth headset and the target terminal is established successfully, receiving a terminal audio signal sent by the target terminal, and playing audio according to the terminal audio signal;

when the two sub-headsets are detected to be attracted together through the attraction device, executing corresponding headset control operation.

Optionally, after the operation of when separation of the two sub-headsets is detected, switching on the Bluetooth headset, and connecting the Bluetooth headset with a corresponding target terminal through Bluetooth, the Bluetooth headset control method also includes:

if no Bluetooth connection is established between the Bluetooth headset and the target terminal within a first preset time, switched off the Bluetooth headset.

Optionally, the operation of when the two sub-headsets are detected to be attracted together through the attraction device, executing corresponding headset control operation includes:

when the two sub-headsets are detected to be attracted together through the attraction device, pausing audio play.

Optionally, after the operations of when the two sub-headsets are detected to be attracted together through the attraction device, pausing audio play, the Bluetooth headset control method also includes:

detecting whether the two sub-headsets are separate within a second preset time;

if the two sub-headsets are separate within the second preset time, resuming audio play;

if the two sub-headsets keep being attracted together within the second preset time, switching off the Bluetooth headsets.

Optionally, the operation of when the two sub-headsets are detected to be attracted together through the attraction device, executing corresponding headset control operation includes:

when the two sub-headsets are detected to be attracted together through the attraction device, switching off the Bluetooth headset.

Optionally, the operation of when the connection between the Bluetooth headset and the target terminal is established successfully, receiving a terminal audio signal sent by the target terminal, and playing audio according to the terminal audio signal includes:

when the connection between the Bluetooth headset and the target terminal is established successfully, and the target terminal is on the phone, then receiving a terminal phone audio signal sent by the target terminal, and playing audio according to the terminal phone audio signal;

the operation of when the two sub-headsets are detected to be attracted together through the attraction device, executing corresponding headset control operation includes:

when the two sub-headsets are detected to be attracted together through the attraction device, sending an instruction of ending the phone to the target terminal to allow the target terminal ending the call.

Optionally, the Bluetooth headset also includes a microphone,

after the operation of when separation of the two sub-headsets is detected, switching on the Bluetooth headset, and connecting the Bluetooth headset with a corresponding target terminal through Bluetooth, the Bluetooth headset control method also includes:

when the connection between the Bluetooth headset and the target terminal is established successfully, the microphone receiving a voice control signal sent by a user, and sending the voice control signal to the target terminal for the target terminal to analyze and process the voice control signal.

Optionally, the two sub-headsets comprise a first sub-headset and a second sub-headset, the first sub-headset includes a U-shaped magnet and a Hall sensor, the Hall sensor is arranged in a U-shaped groove of the U-shaped magnet, and the second sub-headset includes a circular magnet;

the operation of when separation of the two sub-headsets is detected, switching on the Bluetooth headset, and connecting the Bluetooth headset with a corresponding target terminal through Bluetooth includes:

when the Hall sensor detects out that the first sub-headset is separate from the second sub-headset, switching on the Bluetooth headset, and connecting the Bluetooth headset with a corresponding target terminal through Bluetooth;

the operation of when the two sub-headsets are detected to be attracted together through the attraction device, executing corresponding headset control operation includes:

when the Hall sensor detects that the first sub-headset and the second sub-headset are attracted together through the magnets, executing corresponding headset control operation.

In addition, to achieve the above object, the present application also provides a Bluetooth headset, wherein the Bluetooth headset includes an attraction device, and the Bluetooth headset also includes two sub-headsets; and the Bluetooth headset also includes a processor, a memory, and a control program stored in the memory and executable by the processor, wherein when the control program is executed by the processor, the following operation are implement:

when separation of the two sub-headsets is detected, switching on the Bluetooth headset, and connecting the Bluetooth headset with a corresponding target terminal through Bluetooth;

when the connection between the Bluetooth headset and the target terminal is established successfully, receiving a terminal audio signal sent by the target terminal, and playing audio according to the terminal audio signal;

when the two sub-headsets are detected to be attracted together through the attraction device, executing corresponding headset control operation.

In addition, in order to achieve the above object, the present application also provides a computer readable storage medium, a control program is stored in the storage medium, and when the control program is executed by a processor, the following operations are implemented:

When the Bluetooth headset detects out that the two sub-headsets thereof are separate from each other, switching on the Bluetooth headset, and connecting the Bluetooth headset with a corresponding target terminal through Bluetooth;

when the connection between the Bluetooth headset and the target terminal is established successfully, receiving a terminal audio signal sent by the target terminal, and playing audio according to the terminal audio signal;

when the two sub-headsets are detected to be attracted together through the attraction device of the Bluetooth headset, executing corresponding headset control operation.

According to the present application, the Bluetooth headset is defined with an attraction device, which allows the two sub-headsets to be attracted together and separate from each other, and the working state of the Bluetooth headset such as switching on/off, music playing/pausing, and answering/hanging telephone is controlled by the attraction and separation of the two sub-headsets. It is convenient for users to operate, and improves using experience.

### BRIEF DESCRIPTION OF THE DRAWINGS

FIG. 1 is a schematic flow chart of a Bluetooth headset control method in a first embodiment of the present application;

FIG. 2 is a schematic diagram of the attraction involved in the Bluetooth headset control method in the first embodiment of the present application;

FIG. 3 is a schematic flow chart of a Bluetooth headset control method in a second embodiment of the present application.

The realization, functional features and advantages of the purpose of the present disclosure will be further described with reference to the accompanying drawings in conjunction with the embodiments.

### DETAILED DESCRIPTION OF THE EMBODIMENTS

It should be understood that the specific embodiments described herein are only for the purpose of explaining the present disclosure and are not configured to intend to limit the present disclosure.

The Bluetooth headset control method involved in the embodiments of the present application is mainly applied to a Bluetooth headset.

In the embodiments of the present application, the Bluetooth headset may include a processor; and, the processor may be realized by a highly integrated chip, integrating Bluetooth, MCU (Microcontroller Unit), and analog-to-digital conversion (of course, the processor may also integrate other functions. For the Bluetooth, it may include dual-mode Bluetooth, i.e. basic rate/enhanced rate Bluetooth module (BR/EDR) and low power Bluetooth module (BLE); MCU is mainly configured for headset control function, and analog-to-digital conversion part is mainly configured for conversion between analog signals and digital signals. The Bluetooth headset also includes a memory, the memory as a computer readable storage medium may also include an operating system, a network communication module, and a control program. The network communication module is mainly configured to connect terminals and execute data communication with the terminals. In addition, the Bluetooth headset also includes an attraction device through which the two sub-headsets may be attracted together.

Optionally, the Bluetooth headset also includes a Charging port, a Key, a Battery, an indicator light (LED), an acoustoelectric converter (such as a microphone), an electroacoustic converter (Speaker), and an Antenna. For the charging port, it is mainly configured for charging Bluetooth headsets. For the key, it is mainly configured to control the working state of Bluetooth headset. For the battery, it is mainly configured to supply power to Bluetooth headsets. For the indicator light, it is mainly configured to prompt the working status of Bluetooth headset, such as startup prompt, charging prompt, terminal connection prompt, etc. The acoustoelectric converter is mainly configured to convert the collected acoustic signals into electrical signals, which are encoded by Bluetooth play of the processor and then transmitted via Bluetooth. The electroacoustic converter mainly converts electrical signals into sound signals. The antenna is mainly configured for converting electrical signals and wireless electromagnetic wave signals to each other to realize the functions of wireless transmission and receipt of signals.

Those skilled in the art can understand that the above-mentioned hardware structure of the Bluetooth headset does not limit the present application. In practice, the Bluetooth headset may include more or fewer components than the above-mentioned examples, or some components may be combined, or different component arrangements may be used.

The processor of the Bluetooth headset may call the control program stored in the memory and execute the following operations:

when separation of the two sub-headsets is detected, switching on the Bluetooth headset, and connecting the Bluetooth headset with a corresponding target terminal through Bluetooth;

when the connection between the Bluetooth headset and the target terminal is established successfully, receiving a terminal audio signal sent by the target terminal, and playing audio according to the terminal audio signal;

when the two sub-headsets are detected to be attracted together through the attraction device, executing corresponding headset control operation.

The processor of the Bluetooth headset may call the control program stored in the memory and execute the following operations:

if no Bluetooth connection is established between the Bluetooth headset and the target terminal within a first preset time, switched off the Bluetooth headset.

And, the operation of when the two sub-headsets are detected to be attracted together through the attraction device, executing corresponding headset control operation includes:

when the two sub-headsets are detected to be attracted together through the attraction device, pausing audio play.

The processor of the Bluetooth headset may call the control program stored in the memory and execute the following operations:

detecting whether the two sub-headsets are separate within a second preset time;

if the two sub-headsets are separate within the second preset time, resuming audio play;

if the two sub-headsets keep being attracted together within the second preset time, switching off the Bluetooth headsets.

And, the operation of when the two sub-headsets are detected to be attracted together through the attraction device, executing corresponding headset control operation includes:

when the two sub-headsets are detected to be attracted together through the attraction device, switching off the Bluetooth headset.

Optionally, the operation of when the connection between the Bluetooth headset and the target terminal is established successfully, receiving a terminal audio signal sent by the target terminal, and playing audio according to the terminal audio signal includes:

when the connection between the Bluetooth headset and the target terminal is established successfully, and the target terminal is on the phone, then receiving a terminal phone audio signal sent by the target terminal, and playing audio according to the terminal phone audio signal;

the operation of when the two sub-headsets are detected to be attracted together through the attraction device, executing corresponding headset control operation includes:

when the two sub-headsets are detected to be attracted together through the attraction device, sending an instruction of ending the phone to the target terminal to allow the target terminal end the call.

The Bluetooth headset also includes a microphone, and the processor of the Bluetooth headset may call the control program stored in the memory and execute the following operations:

when the connection between the Bluetooth headset and the target terminal is established successfully, the microphone receiving a voice control signal sent by a user, and sending the voice control signal to the target terminal for the target terminal to analyze and process the voice control signal.

Optionally, the two sub-headsets comprise a first sub-headset and a second sub-headset, the first sub-headset includes a U-shaped magnet and a Hall sensor, the Hall sensor is arranged in a U-shaped groove of the U-shaped magnet, and the second sub-headset includes a circular magnet;

the operation of when separation of the two sub-headsets is detected, switching on the Bluetooth headset, and connecting the Bluetooth headset with a corresponding target terminal through Bluetooth includes:

switching on the Bluetooth headset, and connecting the Bluetooth headset with a corresponding target terminal through Bluetooth, when the Hall sensor detects out that the first sub-headset is separate from the second sub-headset.

The operation of executing corresponding headset control operation, when the two sub-headsets are detected to be attracted together through the attraction device, includes:

executing corresponding headset control operation, when the Hall sensor detects that the first sub-headset and the second sub-headset are attracted together through the magnets.

Based on the hardware structure of the Bluetooth headset, various embodiments of the Bluetooth headset control method of the present application are proposed.

The present application provides a Bluetooth headset control method.

Referring to FIG. 1, FIG. 1 is a schematic flow chart of a Bluetooth headset control method in the first embodiment of the present application.

The Bluetooth headset control method in the embodiment is applied to a Bluetooth headset, the Bluetooth headset includes an attraction device, and the Bluetooth headset also includes two sub-headsets; when the Bluetooth headset is in the switch-off state, the two sub-headsets are attracted together through the attraction device; wherein

the Bluetooth headset control method includes the following operations:

operation S10, when separation of the two sub-headsets is detected, switching on the Bluetooth headset, and connecting the Bluetooth headset with a corresponding target terminal through Bluetooth;

With the continuous improvement of technology, the wearable device market has developed rapidly, and numerous types of headsets are emerging, which includes Bluetooth headsets. A Bluetooth headset may connect with its matching terminal wirelessly, thereby users are allowed to use the headset conveniently without the tie of wires. However, currently, for the Bluetooth headsets in the market, the working state thereof is generally controlled in a manner of pressing keys, such as switching on and off the Bluetooth headsets through switch-on and switch-off keys, playing/pausing music through a playing key, which is inconvenient for users. For this, the embodiment provides a Bluetooth headset control method, the Bluetooth headset is defined with an attraction device, which allows the two sub-headsets thereof to be attracted together and separate from each other through the attraction device, and the working state of the Bluetooth headset such as switching on/off, music playing/pausing, and answering/hanging telephone is controlled by the attraction and separation of the two sub-headsets. It is convenient for users to operate, and improves using experience.

Specifically, the Bluetooth headset in this embodiment includes two sub-headsets (left and right headsets), which can be respectively referred as a first sub-headset and a second sub-headset for convenience of description. For the attraction device, it may be realized by a magnet. For example, a magnet is defined at the headset shell of one of the sub-headsets to attract the other sub-headset, of course, the shape of the magnet may be set according to the actual situation. Of course, it is also feasible to respectively define a magnet in each of the two sub-headsets, and the magnet may be defined at the headset shell of the sub-headsets. Through the magnet, the two sub-headsets may be attracted together. Of course, the attraction device may also be realized by other means. In this embodiment, each of the two sub-headsets is defined with a magnet as an example. In addition, other sensors such as Hall sensors and pressure sensors may also be defined in the Bluetooth headset to detect whether the two sub-headsets are in a state of being attracted together or a state of separation.

In this embodiment, when the Bluetooth headset is switched off, the user may place the two sub-headsets close to each other for convenience, that is, allow the two sub-headsets being attracted by the magnets. When a user needs to switch on the Bluetooth headset to execute Bluetooth between the Bluetooth headset and a target terminal, it may separate the two sub-headsets. When the Bluetooth headset detects out that the two sub-headsets are separate, the Bluetooth headset may switch on automatically. After the Bluetooth headset is switched on, it will also connect with a corresponding target terminal via Bluetooth. And, the target terminal may be a terminal with Bluetooth function such as a mobile phone, a tablet computer, a palm computer, a notebook computer. For convenience of explanation, the target terminal in this embodiment is illustrated by taking a mobile phone as an example.

It should be noted that in order to indicate the current state of the Bluetooth headset in this embodiment, the Bluetooth headset may also be indicated by a certain indicator light. For example, when the Bluetooth headset is switched off, the indicator light is off. When the Bluetooth headset is switched on, but no Bluetooth connection is established between it and any terminal, the indicator light may flash. When the Bluetooth transceiver is switched on and a Bluetooth connection is established between it and a target terminal (audio transmission terminal), the indicator lamp may be in a normally-on mode. Through the indicator light, it is convenient for users to directly learn about the current state of the Bluetooth headset.

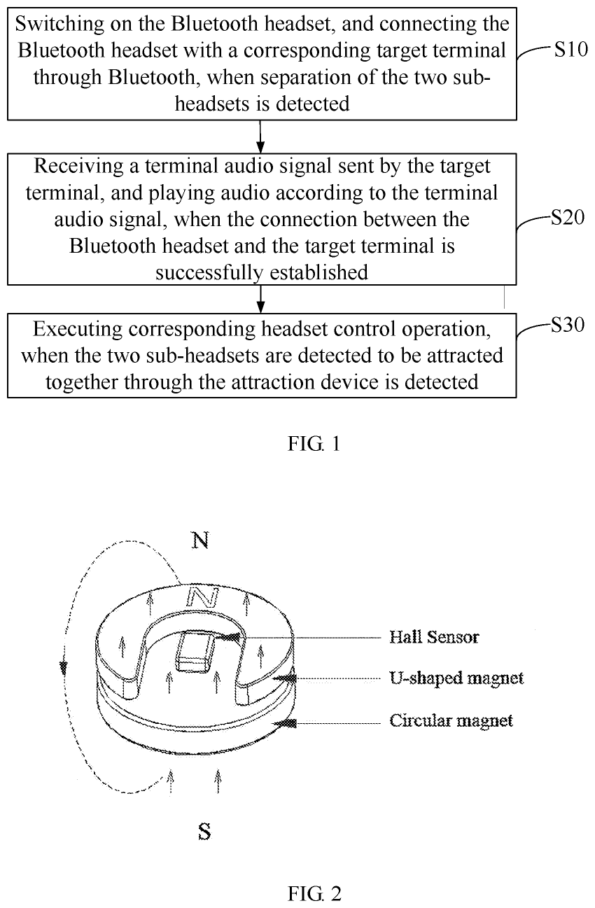

And, in order to improve the detection accuracy of the states as being attracted together/separation of the two sub-headsets of the Bluetooth headset, in this embodiment, a Hall sensor may be defined in the Bluetooth headset, and the detection of the sub-headsets being attracted together or separate is executed by the Hall sensor. Specifically, the magnet of the first sub-headset may be a U-shaped magnet, and a Hall sensor (magnetic field detection sensor) is placed in the middle of the U-shaped magnet. The magnet of the second sub-headset may be a circular magnet. For example, as shown in FIG. 2, FIG. 2 is a schematic diagram of magnets being attracted together (i.e., a simplified schematic diagram of sub-headsets being attracted together). The upper surface of the U-shaped magnet of the first sub-headset is an N pole and the lower surface is an S pole. While the upper surface of the circular magnet is an N pole and the lower surface is an S pole. When the two are attracted together, the magnetic field direction of the hall sensor is from the circular magnet to the hall sensor, i.e. from bottom to top in FIG. 2. When the two are separate, because the upper surface of the U-shaped magnet is N pole and the lower surface is S pole, the magnetic field direction of the Hall sensor may change to be from top to bottom, that is, the magnetic field direction may change. When the Hall sensor detects a change of the direction of the magnetic field, it may transmit the change information to the processor of the Bluetooth headset in the form of an electrical signal, and the processor may determine that the two sub-headsets are separate according to the information, that is, the Bluetooth headset detects out by the Hall sensor that the two sub-headsets are separate. Of course, in practice, the magnet and the Hall sensor may also be defined in other ways, or other sensors may be configured to detect the state of the sub-headsets being attracted together or separate.

operation S20, when the connection between the Bluetooth headset and the target terminal is established successfully, receiving a terminal audio signal sent by the target terminal, and playing audio according to the terminal audio signal;

In this embodiment, the Bluetooth headset may receive a terminal audio signal sent by a mobile phone and play the audio according to the terminal audio signal, after Bluetooth connection between the Bluetooth headset and the mobile phone is established successfully. The process may be that an electroacoustic converter in the Bluetooth headset converts an electrical signal obtained and output by a Bluetooth chip into a corresponding sound signal, and then outputs the sound signal, so that a user may hear relevant audio of a mobile phone through the Bluetooth headset.

In this embodiment, if it fails to establish a Bluetooth connection between the Bluetooth headset and the mobile phone (or other terminals) within a preset time after the Bluetooth headset is switched on, the Bluetooth headset may be automatically switched off. For example, if it fails to establish a Bluetooth connection between the Bluetooth headset and the mobile phone (or other terminals) within 10 minutes after the Bluetooth headset is switched on, the Bluetooth headset may be automatically switched off. Of course, when the Bluetooth headset is automatically switched off, the Bluetooth headset may prompt the user in the form of a prompt tone or a prompt light. After switching off the Bluetooth headset, the user may place the two sub-headsets of the Bluetooth headset together so that the two sub-headsets may be attracted together again. However, since the two sub-headsets of the Bluetooth headset are already in the switch-off state before the re-attraction, the Bluetooth headset may keep in the switch-off state during the detection of the re-attraction of the two sub-headsets. However, when it is detected that the two sub-headsets are separate again, the Bluetooth headsets may automatically switch on again and try to connect with the mobile phone (or other terminals) via Bluetooth.

Operation S30, when the two sub-headsets are detected to be attracted together through the attraction device, executing corresponding headset control operation.

In this embodiment, when the Bluetooth headset is connected with the mobile phone and plays audio, the user may control the Bluetooth headset correspondingly by placing the two sub-headsets so that the two sub-headsets are attracted together again. When the Bluetooth headset detects out that the first sub-headset and the second sub-headset are attracted together again, it may execute the corresponding headset control operation.

For example, the Bluetooth headset may be defined to control audio play through the attraction of the headset. Pause the headset audio play when the re-attraction of the first sub-headset and the second sub-headset is detected. After the pause, the Bluetooth headset may detect whether the two sub-headsets are separate within another preset time (e.g. 5 minutes). If the two sub-headsets are separate within a preset time, it may be considered that the user have resumed using the Bluetooth headset, and the Bluetooth headsets may resume the original audio play in this case, thus providing convenience for the user. However, if the two sub-headsets keep in the state of being attracted together within a preset time, it may be considered that the user does not need to use the Bluetooth headset at present, and the Bluetooth headset may be switched off automatically in this case, thus reducing the consumption of electricity and prolonging the endurance time.

For another example, the Bluetooth headset may be defined to control the switch-off of the headset by the attraction of the headset, and the Bluetooth headset is switched off when the first sub-headset and the second sub-headset are detected to be attracted together again.

It should be noted that when the Bluetooth headset is defined with a Hall sensor, the detection of the headset being attracted together is similar to the detection of the separate state of the headset in operation S20 above, and may also be realized by the Hall sensor detecting the change of the direction of the magnetic field, which will not be repeated herein.

And, in this embodiment, when the two sub-headsets are detected to be attracted together, the operation to be executed by the Bluetooth headset may also be determined according to the working scene before the two sub-headsets are attracted together. Specifically, the operation S30 includes:

In this embodiment, when the Bluetooth headset detects out that the first sub-headset and the second sub-headset are attracted together again by the magnet, it may first detect whether the play of the terminal audio signal in operation S20 has been completed, thus determining the working scene before the Bluetooth sub-headsets are attracted together according to the audio signal play. If the play of terminal audio signal has not been completed, it may be considered that the two sub-headsets are still in the working state before the two sub-headsets are attracted together. In order to resume playing quickly, the Bluetooth headsets may pause the audio play according to the two sub-headsets being attracted together. However, if the play of the terminal audio signal has been completed, the two sub-headsets may be considered to be in a standby state before the two sub-headsets are attracted together again, and the user allows the two sub-headsets being attracted together to stop use of the Bluetooth headset, then the Bluetooth headset may be automatically switched off in this case, thus reducing the consumption of electricity and prolonging the endurance time. After the audio play is paused, the Bluetooth headset may continuously monitor the two sub-headsets being attracted together or separate, and execute other control operations according to the sub-headsets being attracted together or separate. Specifically, if the play of terminal audio signal has not been completed, it may be considered that the two sub-headsets are still in the working state before the two sub-headsets are attracted together. In order to resume playing quickly, the Bluetooth headsets may pause the audio play according to the two sub-headsets being attracted together. After the pause, the Bluetooth headset may detect whether the two sub-headsets are separate within another preset time (e.g. 5 minutes). If the two sub-headsets are separate within a preset time, it may be considered that the user have resumed using the Bluetooth headset, and the Bluetooth headsets may resume the original audio play in this case, thus providing convenience for the user. However, if the two sub-headsets keep in the state of being attracted together within a preset time, it may be considered that the user does not need to use the Bluetooth headset at present, and the Bluetooth headset may be switched off automatically in this case, thus reducing the consumption of electricity and prolonging the endurance time.

It should be noted that the terminal audio signal in this embodiment may be a terminal phone audio signal during a mobile phone call, that is, after the user separates the two sub-headsets of the Bluetooth headset, the user may use the smart headset for a Bluetooth call. In this case, the user may control the end of a call by closing the two sub-headsets. Specifically, in this embodiment, operation S20 includes:

when the connection between the Bluetooth headset and the target terminal is established successfully, and the target terminal is on the phone, then receiving a terminal phone audio signal sent by the target terminal, and playing audio according to the terminal phone audio signal;

In this embodiment, after a Bluetooth connection is established successfully between the Bluetooth headset and the mobile phone, and the mobile phone is on the phone, the mobile phone may send a phone audio signal to the Bluetooth headset. The Bluetooth headset plays according to the phone audio signal, so that the user may also hear the voice on the mobile phone through the Bluetooth headset. The Bluetooth headset may also include a microphone. When on the phone, the Bluetooth headset may also collect the user's voice through the microphone and convert it into a digital signal through a mode converter inside the headset. The digital signal is processed by the Bluetooth chip and then forwarded to the mobile phone through a Bluetooth module, and then the mobile phone transmits it to another party of the call, thus realizing the Bluetooth call function of the headset.

Operation S30 includes:

When it is detected that the first sub-headset and the second sub-headset are attracted together through the magnet, send an end call instruction to the target terminal so that the target terminal ends the call.

In this embodiment, when on the phone, the user needs to end the call (hang up the phone), the two sub-headsets of the Bluetooth headset may be directly attracted together for controlling the mobile phone to end the call. When the Bluetooth headset detects out that the two sub-headsets are together by attraction, it may send a corresponding instruction of ending call to the mobile phone. When the mobile phone receives the end call instruction, it may end the call (hang up the phone) according to the instruction. Through the above manner, a user may indirectly control the call state of a mobile phone through the control of attracting together/separation of the Bluetooth headset, thus making it convenient for the user.

The Bluetooth headset in this embodiment includes a first sub-headset and a second sub-headset, the Bluetooth headset includes an attraction device, and the Bluetooth headset also includes two sub-headsets. When the Bluetooth headset is in the switch-off state, the two sub-headsets are attracted together through the attraction device. When the Bluetooth headset detects out separation of the two sub-headsets is detected, switching on the Bluetooth headset, and connecting the Bluetooth headset with a corresponding target terminal through Bluetooth. when the connection between the Bluetooth headset and the target terminal is established successfully, receiving a terminal audio signal sent by the target terminal, and playing audio according to the terminal audio signal; when the two sub-headsets are detected to be attracted together through the attraction device, executing corresponding headset control operation. Through the above manner, according to this embodiment, the Bluetooth headset is defined with an attraction device, which allows the two sub-headsets of the Bluetooth headset to be attracted together through the attraction device and separate from each other, and the working state of the Bluetooth headset such as switching on/off, music playing/pausing, and answering/hanging telephone is controlled by the attraction and separation of the two sub-headsets. It is convenient for users to operate, and improves using experience.

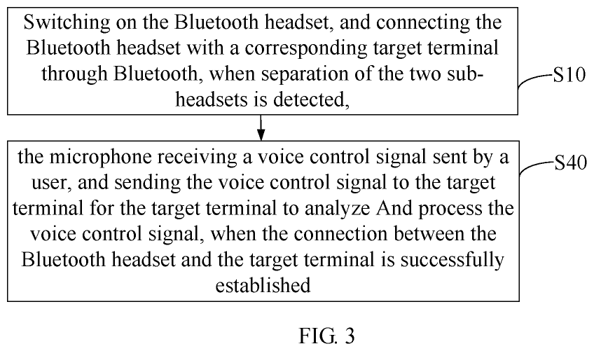

Referring to FIG. 3, FIG. 3 is a schematic flow chart of a Bluetooth headset control method in the second embodiment of the present application.

Based on the above embodiment shown in FIG. 1, in this embodiment, the Bluetooth headset also includes a microphone, and after the operation S10, also includes:

operation S40, when the connection between the Bluetooth headset and the target terminal is established successfully, the microphone receiving a voice control signal sent by a user, and sending the voice control signal to the target terminal for the target terminal to analyze and process the voice control signal.

In this embodiment, the Bluetooth headset may also carry out data interaction with a mobile phone after the Bluetooth connection is established successfully between the mobile phone and the Bluetooth headset, so that a user may send relevant voice control information to the mobile phone through a voice from the Bluetooth headset to realize voice control on the mobile phone. Specifically, the Bluetooth headset may also be defined with a microphone to collect relevant voice signals sent by users. When the Bluetooth headset is successfully connected with the mobile phone, it may be prompted that the connection with the mobile phone is currently established by means of a prompt light or a prompt tone. In this case, the user may speak out a relevant control voice to the microphone of the Bluetooth headset. When the Bluetooth headset receives the voice control signal sent by the user through the microphone, the Bluetooth headset may send the voice control signal to the mobile phone in a Bluetooth communication mode so as to carry out voice control on the mobile phone. When receiving the voice control signal, the mobile phone may analyze the voice control signal, judge the meaning of the user's speech, and then carry out corresponding processing according to the meaning, or execute corresponding operations, such as answering incoming calls, changing a certain setting of the mobile phone, playing a certain song, controlling household appliances, etc. The analysis process on the voice control signal by the mobile phone may be that the mobile phone sends the voice control signal to the cloud, and the cloud sends the analysis result back to the mobile phone after the cloud complete the analysis of the voice control signal, and the mobile phone executes corresponding operations according to the analysis result. In addition, the Bluetooth headset in this embodiment may also realize the networking function, that is, voice interactive control on other devices except mobile phones. Specifically, the mobile phone may be connected with other equipment (such as household appliances) while being connected with the Bluetooth headset. For convenience of description, the other equipment is illustrated by taking air conditioner as an example. When a user wants to adjust the cooling temperature of an air conditioner, he or she may take out the Bluetooth headset and separate the two sub-headsets of the Bluetooth headset that were together by attraction. At this time, the Bluetooth headset is switched on and connected with the mobile phone via Bluetooth. Then, the user may speak out a relevant voice about control on the air conditioner to the microphone of the Bluetooth headset. When the Bluetooth headset receives the voice control signal sent by the user through the microphone, the Bluetooth headset may send the voice control signal to the mobile phone in a Bluetooth communication mode. When receiving the voice control signal, the mobile phone may analyze the voice control signal (send the voice control signal to the cloud, and then return the analysis result to the mobile phone after the cloud analysis is completed), When the analysis is completed, the mobile phone may send a corresponding instruction of adjusting cooling temperature to the air conditioner according to the analysis result, thereby adjusting the cooling temperature of the air conditioner. Through the above manner, a user may send relevant voice control information to the mobile phone through a voice from the Bluetooth headset to realize voice control on the mobile phone.

In addition, the present application also provides a computer readable storage medium.

The computer readable storage medium of the present application stores a control program, wherein when the control program is executed by the processor, the operations of the Bluetooth headset control method as described above are implemented.

And, the method implemented when the control program is executed may refer to various embodiments of the Bluetooth headset control method of the present application, and will not be repeated here.

It should be noted that in this document, the terms “comprise”, “include” or any other variation thereof, are intended to cover a non-exclusive inclusion, such that a process, method, article, or system that includes a series of elements includes not only those elements but also other elements not expressly listed, or elements inherent to such process, method, article, or system. Without further limitation, the element defined by the statement “include one . . . ” does not exclude the existence of another identical element in the process, method, article or system that includes the element.

The above-mentioned serial numbers of the embodiments of the present disclosure are for the purpose of description only and do not represent the advantages and disadvantages of the embodiments.

From the description of the above embodiments, it is clear to those skilled in the art that the method of the above embodiments may be implemented by means of software and necessary general-purpose hardware platform, although it may also be implemented by hardware, but in many cases the former is a preferred embodiment. Based on this understanding, the technical solution of the present application can be embodied in the form of a software product, which is stored in a storage medium (such as ROM/RAM, magnetic disk, optical disk) as described above, and includes several instructions to cause a terminal device (which can be a mobile phone, a computer, a server, an air conditioner, or a network device, etc.) to execute the methods described in various embodiments of the present application.

The above is only an alternative embodiment of the present disclosure and is not intended to limit the patent scope of the present disclosure. Any equivalent structure or equivalent process transformation made by using the contents of the specification and drawings of the present disclosure, or directly or indirectly applied in other related technical fields, is similarly included in the patent protection scope of the present disclosure.

What is claimed is:

1. A Bluetooth headset control method, wherein the Bluetooth headset control method is applied to a Bluetooth headset, the Bluetooth headset comprises an attraction device, and the Bluetooth headset further comprises two sub-headsets; when the Bluetooth headset is in the switch-off state, the two sub-headsets are attracted together through the attraction device;
the Bluetooth headset control method comprises the following operations:
switching on the Bluetooth headset and connecting the Bluetooth headset with a corresponding target terminal through Bluetooth when separation of the two sub-headsets is detected; receiving a terminal audio signal sent by the target terminal and playing audio according to the terminal audio signal when the connection between the Bluetooth headset and the target terminal is successfully established; and
executing corresponding headset control operation when the two sub-headsets are detected to be attracted together through the attraction device.

2. The control method according to claim 1, wherein after the operation of switching on the Bluetooth headset and connecting the Bluetooth headset with a corresponding target terminal through Bluetooth when separation of the two sub-headsets is detected, the Bluetooth headset control method further comprises:
switching off the Bluetooth headset if no Bluetooth connection is established between the Bluetooth headset and the target terminal within a first preset time.

3. The control method according to claim 1, wherein the operation of executing corresponding headset control operation when the two sub-headsets are detected to be attracted together through the attraction device comprises:
pausing audio play when the two sub-headsets are detected to be attracted together through the attraction device.

4. The control method according to claim 3, wherein after the operation of pausing audio play when the two sub-headsets are detected to be attracted together through the attraction device, the Bluetooth headset control method further comprises:
detecting whether the two sub-headsets are separate within a second preset time;
resuming audio play if the two sub-headsets are separate within the second preset time;
switching off the Bluetooth headsets if the two sub-headsets keep being attracted together within the second preset time.

5. The control method according to claim 1, wherein the operation of executing corresponding headset control operation when the two sub-headsets are detected to be attracted together through the attraction device comprises:
switching off the Bluetooth headset when the two sub-headsets are detected to be attracted together through the attraction device.

6. The control method according to claim 1, wherein the operation of receiving a terminal audio signal sent by the target terminal and playing audio according to the terminal audio signal when the connection between the Bluetooth headset and the target terminal is successfully established comprises:
receiving a terminal phone audio signal sent by the target terminal and playing audio according to the terminal phone audio signal, when the connection between the Bluetooth headset and the target terminal is successfully established and the target terminal is on the phone;
the operation of executing corresponding headset control operation when the two sub-headsets being detected to be attracted together through the attraction device, comprises:
sending an instruction of ending the phone to the target terminal to allow the target terminal ending the call when the two sub-headsets are detected to be attracted together through the attraction device.

7. The control method according to claim 1, wherein the Bluetooth headset further comprises a microphone,
after the operation of switching on the Bluetooth headset and connecting the Bluetooth headset with a corresponding target terminal through Bluetooth when separation of the two sub-headsets is detected, the Bluetooth headset control method further comprises:
receiving a voice control signal sent by a user via the microphone and sending the voice control signal to the target terminal for the target terminal to analyze and process the voice control signal when the connection between the Bluetooth headset and the target terminal is successfully established.

8. The control method according to claim 1, wherein the two sub-headsets comprise a first sub-headset and a second sub-headset, the first sub-headset comprises a U-shaped magnet and a Hall sensor, the Hall sensor is arranged in a U-shaped groove of the U-shaped magnet, and the second sub-headset comprises a circular magnet;
the operation of switching on the Bluetooth headset, and connecting the Bluetooth headset with a corresponding target terminal through Bluetooth when separation of the two sub-headsets is detected comprises:
switching on the Bluetooth headset and connecting the Bluetooth headset with a corresponding target terminal through Bluetooth when the Hall sensor detects that the first sub-headset is separated from the second sub-headset;
the operation of executing corresponding headset control operation when the two sub-headsets are detected to be attracted together through the attraction device, comprises:
executing corresponding headset control operation when the Hall sensor detects that the first sub-headset and the second sub-headset are attracted together through the magnets.

9. A Bluetooth headset, wherein the Bluetooth headset comprises an attraction device, and the Bluetooth headset further comprises two sub-headsets; and the Bluetooth headset further comprises a processor, a memory, and a control program stored in the memory and executable by the processor, wherein when the control program is executed by the processor, the following operation are implement:
when separation of the two sub-headsets is detected, switching on the Bluetooth headset, and connecting the Bluetooth headset with a corresponding target terminal through Bluetooth;
receiving a terminal audio signal sent by the target terminal, and playing audio according to the terminal audio signal, when the connection between the Bluetooth headset and the target terminal is successfully established;
executing corresponding headset control operation, when the two sub-headsets are detected to be attracted together through the attraction device.

10. The Bluetooth headset according to claim 9, wherein the following operations are further implemented, when the control program is executed by the processor:
switching off the Bluetooth headset, if no Bluetooth connection is established between the Bluetooth headset and the target terminal within a first preset time.

11. The Bluetooth headset according to claim 9, wherein the operation of executing corresponding headset control operation when the two sub-headsets are detected to be attracted together through the attraction device comprises:
pausing audio play, when the two sub-headsets are detected to be attracted together through the attraction device.

12. The Bluetooth headset according to claim 11, wherein the following operations are further implemented when the control program is executed by the processor:
detecting whether the two sub-headsets are separate within a second preset time;
resuming audio play, if the two sub-headsets are separate within the second preset time;
switching off the Bluetooth headsets, if the two sub-headsets keep being attracted together within the second preset time.

13. The Bluetooth headset according to claim 9, wherein the following operations are further implemented when the control program is executed by the processor:
switching off the Bluetooth headset, when the two sub-headsets are detected to be attracted together through the attraction device.

14. The Bluetooth headset according to claim 9, wherein the operation of receiving a terminal audio signal sent by the target terminal, and playing audio according to the terminal audio signal when the connection between the Bluetooth headset and the target terminal is successfully established comprises:
receiving a terminal phone audio signal sent by the target terminal, and playing audio according to the terminal phone audio signal, when the connection between the Bluetooth headset and the target terminal is established successfully and the target terminal is on the phone;
the operation of executing corresponding headset control operation when the two sub-headsets are detected to be attracted together through the attraction device, comprises:
sending an instruction of ending the phone to the target terminal to allow the target terminal ending the call, when the two sub-headsets are detected to be attracted together through the attraction device.

15. The Bluetooth headset according to claim 9, wherein the Bluetooth headset further comprises a microphone, the following operations are further implemented when the control program is executed by the processor:
the microphone receiving a voice control signal sent by a user, and sending the voice control signal to the target terminal for the target terminal to analyze and process the voice control signal, when the connection between the Bluetooth headset and the target terminal is successfully established.

16. The Bluetooth headset according to claim 9, wherein the two sub-headsets comprise a first sub-headset and a second sub-headset, the first sub-headset comprises a U-shaped magnet and a Hall sensor, the Hall sensor is arranged in a U-shaped groove of the U-shaped magnet, and the second sub-headset comprises a circular magnet;
the operation of switching on the Bluetooth headset, and connecting the Bluetooth headset with a corresponding target terminal through Bluetooth when separation of the two sub-headsets is detected comprises:
switching on the Bluetooth headset, and connecting the Bluetooth headset with a corresponding target terminal through Bluetooth, when the Hall sensor detects that the first sub-headset is separate from the second sub-headset;
the operation of executing corresponding headset control operation when the two sub-headsets are detected to be attracted together through the attraction device comprises:
executing corresponding headset control operation, when the Hall sensor detects that the first sub-headset and the second sub-headset are attracted together through the magnets.

17. A computer readable storage medium, wherein a control program is stored in the computer readable storage medium, wherein the following operations are implemented, when the control program is executed by a processor:
switching on the Bluetooth headset, and connecting the Bluetooth headset with a corresponding target terminal through Bluetooth, when the Bluetooth headset detects that the two sub-headsets thereof are separate from each other;
receiving a terminal audio signal sent by the target terminal, and playing audio according to the terminal audio signal, when the connection between the Bluetooth headset and the target terminal is successfully established;
executing corresponding headset control operation, when the two sub-headsets are detected to be attracted together through the attraction device of the Bluetooth headset.

18. The storage medium according to claim 17, wherein the following operations are further implemented when the control program is executed by the processor:
switching off the Bluetooth headset, if no Bluetooth connection is established between the Bluetooth headset and the target terminal within a first preset time.

19. The storage medium according to claim 17, wherein the operation of executing corresponding headset control operation when the two sub-headsets are detected to be attracted together through the attraction device comprises:
pausing audio play, when the two sub-headsets are detected to be attracted together through the attraction device.

20. The storage medium according to claim 17, wherein the following operations are further implemented when the control program is executed by the processor:
detecting whether the two sub-headsets are separate within a second preset time;
resuming audio play, if the two sub-headsets are separate within the second preset time;
switching off the Bluetooth headsets, if the two sub-headsets keep being attracted together within the second preset time.
